(19) United States
(12) Patent Application Publication
(10) Pub. No.: US 2020/0245049 A1
(43) Pub. Date: Jul. 30, 2020

(54) FLEX-FIT EAR TIP FOR HEADPHONES

(71) Applicant: Harman International Industries, Incorporated, Stamford, CT (US)

(72) Inventors: Effrosini A. KARAYIANNIS, Manchester, MO (US); Kim Hyo JIN, Stamford, CT (US); Derek CAMPBELL, Stamford, CT (US)

(21) Appl. No.: 16/258,055

(22) Filed: Jan. 25, 2019

(51) Int. Cl. H04R 1/10

(52) U.S. Cl. CPC H04R 1/105; H04R 1/1041; H04R 1/1016

(57) ABSTRACT

In at least one embodiment, a headphone apparatus including an earbud is provided. The earbud includes a housing, a flexible skirt, and a flexible tip portion. The housing includes a loudspeaker positioned therein and at least a portion of the housing being arranged to be received in a user's concha. The flexible skirt is removably coupled to at least a portion of the housing to be at least partially received in an ear canal of the user. The flexible tip portion extends from the housing and the flexible tip portion is configured to be received in at least an antihelix of the user. The flexible tip portion includes an outer wall and a rib intersecting with the outer wall such that the outer wall applies a force against the rib in response to contact with an anti-helical fold of the user's ear.

### TECHNICAL FIELD

Aspects disclosed herein generally relate to a headphone apparatus including an earbud that plays back audio data for a user. These aspects and other will be discussed in more detail below.

### BACKGROUND

U.S. Publication No. 2017/0339481 to Laberge discloses an earpiece system comprising an enhancer. The enhancer is configured to receive an earbud of a speaker and to fit in a user's ear. The enhancer includes a first portion having a first surface that defines a concave crus relief feature. The enhancer further includes a second portion extending from the first portion and forming a sound tunnel having an opening at an end opposite the first portion, and a flexible skirt positioned with the sound tunnel and projecting over the second portion to resiliently seal with the user's ear canal when inserted therein.

U.S. Publication No. 2015/0030194 to Burgett et al. provides, among other things, an earbud adapter or in-ear monitor that includes an ear interface that fits the human ear and further permits the wearer of these devices to adjust parameters of the fit. In additional aspects, the ear interface portion of these devices permits the user to adjust the transmission of ambient sound. The ear interface portion also allows the user to change ornamentation.

### SUMMARY

In at least one embodiment, a headphone apparatus including an earbud is provided. The earbud includes a housing, a flexible skirt, and a flexible tip portion. The housing includes a loudspeaker positioned therein and at least a portion of the housing being arranged to be received in a user's concha. The flexible skirt is removably coupled to at least a portion of the housing to be at least partially received in an ear canal of the user. The flexible tip portion extends from the housing. The flexible tip portion is configured to be received in at least an antihelix of the user. The flexible tip portion includes an outer wall and a rib intersecting with the outer wall such that the outer wall applies a force against the rib in response to contact with an anti-helical fold of the user's ear.

In at least another embodiment, a headphone apparatus including an earbud is provided. The earbud includes a housing, a flexible skirt, and a flexible tip portion. The housing includes a loudspeaker positioned therein and at least a portion of the housing is arranged to be received in a user's concha. The flexible skirt is removably coupled to at least a portion of the housing to be at least partially received in an ear canal of the user. The flexible tip portion extends from the housing. The flexible tip potion is configured to be received in at least an antihelix of the user. The flexible tip portion includes an outer wall and a rib intersecting with the outer wall such that the outer wall applies a force against the rib in response to contact from an anti-helical fold of user's ear.

In at least another embodiment, a headphone apparatus including an earbud is provided. The earbud includes a housing, a flexible skirt, and a flexible tip portion. The housing includes a loudspeaker positioned therein and at least a portion of the housing is arranged to be received in a user's concha. The flexible skirt being is removably coupled to at least a portion of the housing to be at least partially received in an ear canal of the user. The flexible tip portion extends from the housing. The flexible tip potion is configured to be received in at least an antihelix of the user. The flexible tip portion includes an outer wall and a plurality of ribs being spaced apart from one another. The outer wall is configured to apply a force against the plurality of ribs in response to contact with in response to contact with a corresponding anatomical feature of the user's ear.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 depicts a view of a headphone apparatus in accordance to one embodiment;

FIG. 2 depicts a detailed view of a flex tip portion of an earbud of the headphone apparatus in accordance to one embodiment;

FIG. 3 depicts a view of a left human ear and corresponding anatomical parts;

FIG. 4 depicts a rear view of the flex tip portion of the earbuds of the headphone apparatus in accordance to one embodiment; and

FIG. 5 depicts a side view of the earbuds of the headphone apparatus in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects disclosed herein generally provide for a headphone apparatus that includes earbuds (or in-ear headphones) with each earbud being at least partially inserted into a corresponding ear canal of a user. Each earbud provides an audio signal into the ear canal of the user. The earbud generally includes an enhancer that is positioned over a main body section of a housing. The main body section may be formed of hard plastic. The enhancer may be formed of silicon and and provides comfort for the user when the earbud is inserted into the ear. For example, the enhancer may fit into a concha of the user's ear. In some cases, the enhancer may not fit properly into the concha of the ear for the user, particularly with respect to an upper portion of the concha.

The disclosed earbud includes a flex-fit ear tip portion (or “flex tip portion”) that is integrated with the enhancer. The ear tip portion is generally positioned within the upper portion of the concha and into an antihelix of the user's ear. The ear tip portion includes perforated vents (or compression openings) that are separated by ribs. The venting (or openings) on the flex tip portion is directional and angular for improved compression when the ear tip portion is inserted into the upper portion of the concha and into the antihelix of the user's ear. The shape of the vents is angled in a direction parallel to the flex tip portion itself, so that the flex-tip portion may compress freely and allow the flex tip portion (or wing) to adapt to the size of the user's antihelix. This adaption of the size of the flex tip portion may provide for a semi-custom fit for the user and may further alleviate pressure that would otherwise be felt in an underside of an anti-helix (or anti-helical fold) of the ear. This aspect generally provides some degree of pain if such an adaptation of the size of the flex tip portion was not permitted. In light of the foregoing, the headphone apparatus and associated earbuds provided herein may, among other things, provide a stable fit of the earbud into the user's ear during workouts performed by the user, relieve pain for earbuds that provide an ear tip portion that does not properly fit within the anti-helix, and/or create a recognizable visual cue of sport and comfort that may be associated with a particular brand of the headphone apparatus over time. These aspects and others will be discussed in more detail below.

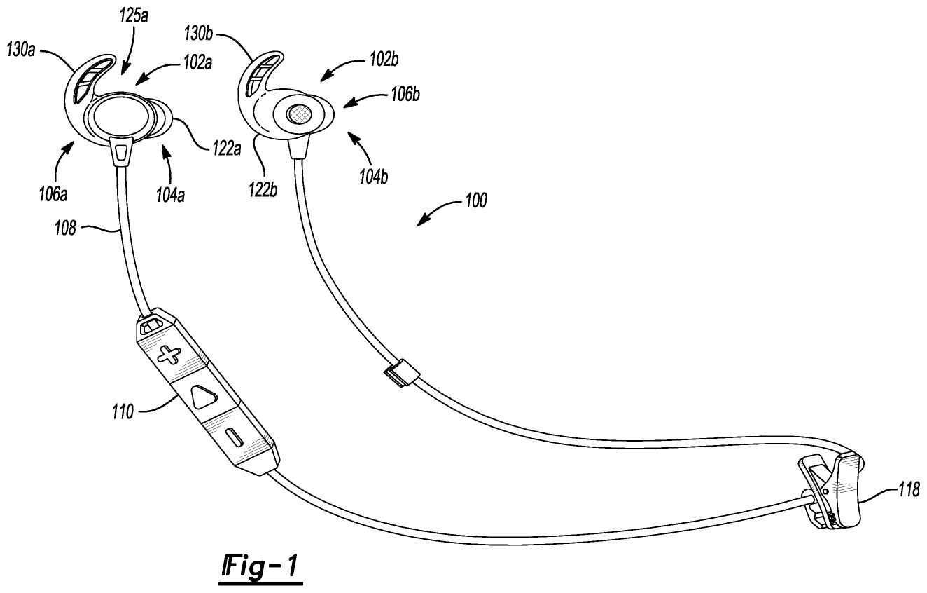

FIG. 1 depicts a view of a headphone apparatus (or headphones) 100 in accordance to one embodiment. The headphone 100 generally includes earphones (or earbuds) 102a-102b (or “102”). The earbuds 102a, 102b generally include housings 104a, 104b (or “104”), respectively. The housing 104 may be constructed of plastic, steel, etc. A mobile device (not shown) or other media playback device (not shown) may transmit audio data to the apparatus 100 to playback audio data for the user. The earbuds 102a and 102b include transducers 106a, 106b, respectively, to playback audio data for the user. In another example, the headphones 100 may include memory (not shown) positioned in at least one of the housings 104 to store the audio data and to playback the same for the user as opposed to the mobile device providing the audio data for the headphones 100. It is recognized that the headphones 100 may not be used exclusively for audio playback. For example, the headphones 100 may also include a microphone (not shown) to receive an audio input from the user. The headphones 100 may in turn transmit the audio input to a mobile device, speaker phone (or bridge) for teleconferences, etc. or other suitable device used in connection with the transmission of audio data from the headphones 100.

In addition, the headphones 100 may be used as bionic headphones. In this case, one or more microphones (not shown) positioned within the headphones 100 may capture ambient audio external to the headphones 100. When a predetermined ambient audio signal is captured by the headphones 100, the headphones 100 may mute the audio that is being played back or reduce the volume level of the audio that is being played back (i.e., auto adjust noise level down when ambient noises occur) to enable the user to hear the predetermined ambient audio signal. In this example, the headphones 100 may be considered to provide super-sonic hearing that enables the user to listen to ambient noise when listening to music under any number of usage profiles.

In one embodiment, a flexible coated wire 108 is attached to each end of the housings 104a, 104b. The coated wire 108 generally includes electrical wiring to facilitate electrical communication between the electronics (not shown) positioned within each housing 104a and 104B. A switch 110 is positioned between the housing 104a and 104b and is configured to adjust a volume level for the audio that is played back to the user via the headphones 100. It is recognized that the switch 110 may provide other functionality such as pairing operations between the headphones 100 and the mobile device (not shown), power on/off, etc. A clip 118 may be positioned on the flexible coated wire 108 so that the user can attached the headphones 100 to clothing or other suitable device to prevent the headphones 100 from being lost or misplaced.

In another embodiment, the headphones 100 may not require the coated wire 108 and each corresponding earbud 102a, 102b may wireless receive audio data from an audio source and provide the same to the user. In this case, the switch 110 may be positioned directly on one or more the earbuds 102a, 102b to control functions of the headphones 100 (e.g., adjust volume, mute, answer phone call, etc.). A separate controller may not be required for the wireless based earbud implementation.

The earbuds 102a, 102b generally include a flexible skirt 122a, 122b (or “122”), respectively, and an enhancer 125a, 125b (or “125”), respectively. The enhancer 125 may be removably coupled to a main body section (not shown) of the housing 104. The housing 104 includes a sound tunnel (not shown) that defines an audio channel for providing audio to the user from the transducer 106. The flexible skirt 122 is removably coupled to the sound tunnel. The flexible skirt 122 may take on any number of shapes and sizes. The flexible skirt 122 is at least partially inserted into an ear canal of a user to provide the audio data. The enhancer 125 is generally positioned within the concha of a user' ear to provide comfort for the user. The enhancer 125 may be formed of silicone or other suitable material.

Each enhancer 125a, 125b generally includes a flexible tip portion (or flex-tip portion) 126a, 126b (or “126”), respectively. The flex-tip portion 126 may be integrated with the enhancer 125 and may also be formed of silicone. The flex-tip portion 126 may be positioned within the cymba of the concha and the antihelix of the ear. The flex-tip portion 126 is generally configured to compress within a cymba of the concha and antihelix of the ear to alleviate pressure that would otherwise be felt in an underside of an anti-helical fold of the ear when the earbuds 102a, 102b are inserted into a corresponding ear canal of the use. These aspects will be discussed in more detail below.

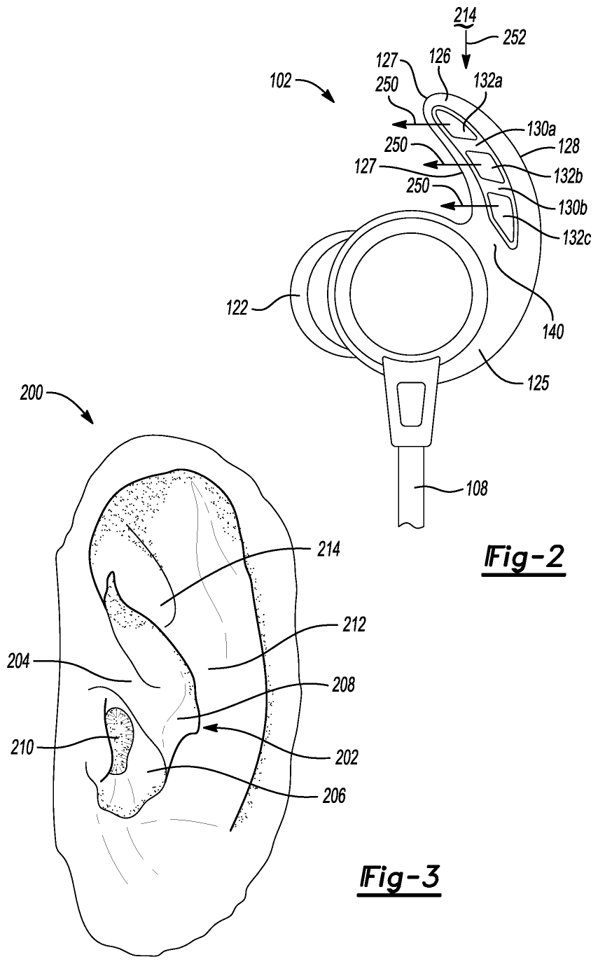

FIG. 2 depicts a detailed view of the flex tip portion 126 of the enhancer 125 of the headphone apparatus 100 in accordance to one embodiment. The flex tip portion 126 may be arcuately shaped to fit within the antihelix of the ear. The flex tip portion 126 generally includes an interior wall 127 formed on an interior portion thereof and an outer wall 128 formed on an exterior portion thereof. The inner wall 127 is generally oriented or positioned closest to a front face of the user. The outer wall 128 is generally orientated or positioned closest to a back of the head of the user. The interior wall 127 and the outer wall 128 are integrated with one another at a top section 129 of the flex tip portion 126. The flex tip portion 126 generally includes a plurality of flexible ribs 130a-130b that are spaced apart from one another. Each of the ribs 130a and 130b extend about an axis to intersect the outer wall 128 and the inner wall 127. The ribs 130a and 130b may or may not be parallel with one another. The inner wall 127, the outer wall 128, and the ribs 130a and 130b are integrally formed with one another. Each of the ribs 130a and 130b extend about an axis to intersect with the inner wall 127 and the outer wall 128. In addition, each rib 130a and 130b and corresponding sections of the inner wall 127 and the outer wall 128 define corresponding compression chambers (or compression openings) 132a and 132b, respectively. An upper portion 140 of the enhancer 125, the rib 130b, a corresponding section of the inner wall 127, and a corresponding section of the outer wall 128 define a compression opening 132c. In general, upon insertion of the earbud 102 into the ear, an anti-helical fold of the ear may apply a force on the outer wall 128 thereby forcing the outer wall 128, the inner wall 127, the ribs 130a, 130b and the compression openings 132a, 132b, and 132c to move in a generally horizontal direction to enable the flex tip portion 126 to compress into the concha and into the antihelix of the ear. This aspect generally enables the flex tip portion 126 to remain securely and comfortably positioned within the concha and the antihelix of the ear.

FIG. 3 generally illustrates anatomical features of the human ear 200 and is set forth to provide a reference to illustrate the manner in which the flex tip portion 126 is positioned within the ear 200 of the user. The ear 200 includes a concha 202 and a crus helix 204. The concha 202 generally includes a cavum 206 and a cymba 208. The crus helix 204 generally separates the cymba 208 from the cavum 206. An ear canal 210 is positioned proximate to the cavum 206. The ear 200 further includes an antihelix 212 and anti-helical fold 214. The antihelix 212 at least partially surrounds the cavum 206 which is recessed into the ear 200. As the earbud 102 is inserted the ear 200, the flexible skirt 122 of the earbud 102 is generally positioned (or inserted) within the ear canal 210 and the enhancer 125 may be positioned within the cavum 206 of the concha 202. The enhancer 125 may be at least partially positioned over the crus helix 204 and/or over a lower portion of the cymba 208. The flex tip portion 126 may be positioned over (or within) the cymba 202 and at least partially within a boundary of the antihelix 212. The flex tip portion 126 is generally configured to flex (or compress) under the anti-helical fold 214 of the ear 200.

In reference back to FIG. 2, the flex tip portion 126 is generally configured to compress or flex generally along a first axis 250 (e.g., horizontal axis) as the anti-helical fold 214 applies a generally vertical (or generally downward) force 252 against one or more sections of the outer wall 128. The outer wall 128 may apply a force against the plurality of ribs 130a and 130b in response to contact from the anti-helical fold 214. Alternatively, the anti-helical fold 214 may compress the outer wall 128 in a generally downward manner which in turn causes the outer wall 128, the inner wall 127, the ribs 130a-130b to move along the first axis 250 to compress into the cymba 208 (i.e., the concha) and within the antihelix 214. It is recognized that the anatomical features of the ear 200 vary from user to user and the amount of force as applied by anti-helical fold 214 will vary based on the user's corresponding ear anatomy. The movement of the flex tip portion 126 about the first axis 250 enables the flex tip portion 126 to securely attach to the user's ear 200 and prevents any pain and discomfort due to the force or compression applied from the antihelical fold 214. The ribs 130a-130b may provide a counter force against the outer wall 128 to provide stability to ensure that the flex tip portion 126 remains securely attached to the concha 202 and to the antihelix 212 of the ear 200. In addition, the compression openings 132a-132c enable adequate compression of the outer wall 128 in response to the force applied by the anti-helical fold 214 to prevent pain and discomfort for the user.

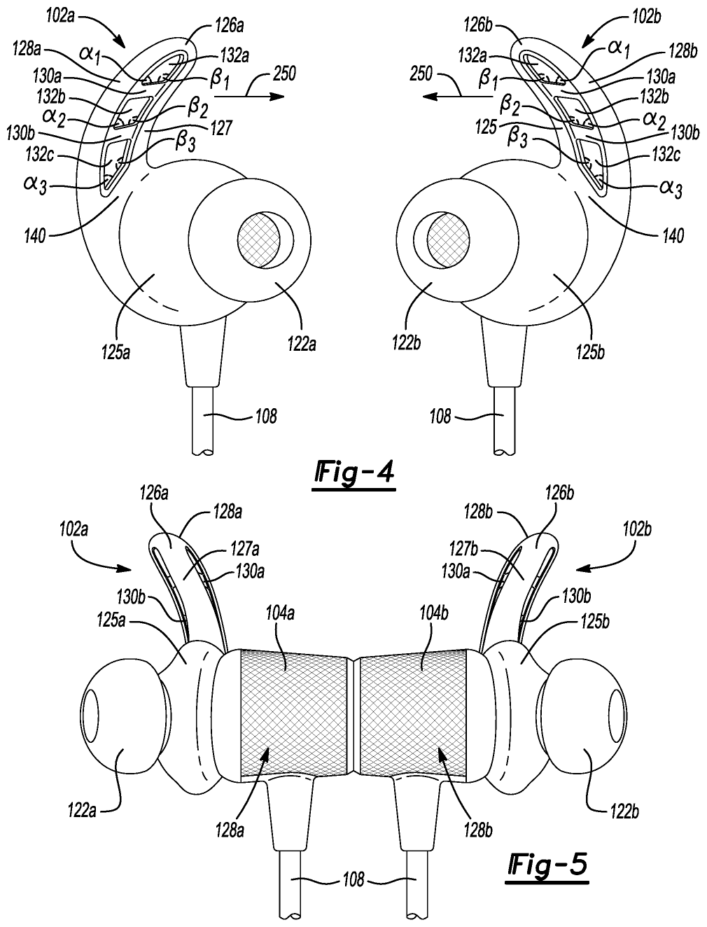

FIG. 4 depicts a rear view of the flex tip portions 126a and 126b for the corresponding earbuds 102a and 102b, respectively, of the headphones 100. Each compression opening 130a, 130b, and 130c forms an angle α₁, α₂, and α₃ at a lower portion thereof that is generally less than 90 degrees. Such a formation enables the flex tip portion 126 (e.g., the outer wall 128) to compress at least partially along the first axis 250. Likewise, each compression opening 130a, 130b, and 130c forms an angle β₁, angle β₂, and angle β₃ at an opposite portion of the lower portion that is generally greater than 90 degrees to enable the flex tip portion 126 (e.g., the inner wall 127) to compress along the first axis 250. In general, the overall length for any corresponding compression opening 132a, 132b, and 132c may be, for example, within a range of 1.8 to 3.0 mm. The overall width of the outer wall 128 may be, for example, within a range of 2.0 to 3.3 mm and the overall width of the inner wall 127 may be, for example, within a range of 0.6 to 1.5 mm. An overall thickness for any one of the ribs 130a and 130b may be within a range of 0.8 to 1.5 mm. Such dimensions may enable the flex tip portion 126 to provide an adequate level of compression when positioned within the ear 200 and further enable the flex tip portion 126 to be securely attached to the ear 200 and provide comfort for the user.

FIG. 5 depicts a side view of the earbuds 102a, 102b of the headphones 100 in accordance to one embodiment. As shown, an overall thickness of the ribs 130a, 130b may be less than the overall thickness of the outer wall 128. This aspect further aids in the compression of the outer wall 128 under the force applied by the from the antihelical fold 214. In addition, the overall thickness of the ribs 130a, 130b may be greater than the overall thickness of the inner wall 127. These aspects may also enable the flexible tip portion 126 to move or compress against the force applied from the antihelical fold 214 and may also enable the flexible tip portion 126 to remain securely attached to the ear 200 of the user.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A headphone apparatus comprising:
an earbud including:
a housing including a loudspeaker positioned therein, at least a portion of the housing being arranged to be received in a user's concha;
a flexible skirt being removably coupled to at least a portion of the housing to be at least partially received in an ear canal of the user; and
an enhancer removably coupled to the housing, the enhancer including a flexible tip portion extending from an upper portion of the enhancer, the flexible tip portion being configured to be received in at least an antihelix of the user, the flexible tip portion including an outer wall, an inner wall positioned opposite to the outer wall and a transverse rib intersecting with the outer wall and the inner wall, such that the outer wall applies a force against the rib in response to contact with an anti-helical fold of the user's ear.

2. (canceled)

3. The headphone apparatus of claim 1, wherein a thickness of the outer wall is greater than a thickness of the rib.

4. The headphone apparatus of claim 1, wherein a thickness of the rib is greater than a thickness of the inner wall.

5. The headphone apparatus of claim 1, wherein the outer wall, the inner wall, and the rib are integrally formed with one another.

6. The headphone apparatus of claim 1, wherein a first portion of the outer wall, a first portion of the inner wall, and the rib define a compression opening to enable the outer wall to compress into the compression opening along an axis in response to contact with the anti-helical fold of the user's ear.

7. The headphone apparatus of claim 6, wherein the compression opening forms a first angle that is less than 90 degrees at a first portion thereof.

8. The headphone apparatus of claim 7, wherein the compression opening forms a second angle that is greater than 90 degrees at a second portion thereof, the second portion being positioned opposite to the first portion.

9. The headphone apparatus of claim 1, wherein the flexible tip portion is arcuately shaped to fit within the antihelix of the ear.

10. The headphone apparatus of claim 1, wherein flexible tip moves at least partially along a generally horizontal axis in response to contact with the anti-helical fold.

11-19. (canceled)

20. A headphone apparatus comprising:
an earbud including:
a housing including a loudspeaker positioned therein, at least a portion of the housing being arranged to be received in a user's concha;
a flexible skirt being removably coupled to at least a portion of the housing to be at least partially received in an ear canal of the user; and
an enhancer removably coupled to the housing, the enhancer including a flexible tip portion extending from an upper portion of the enhancer, the flexible tip portion being configured to be received in at least an antihelix of the user, the flexible tip portion including an outer wall, an inner wall positioned opposite to the outer wall, and a plurality of transverse ribs being spaced apart from one another and intersecting the outer wall and the inner wall, the outer wall being configured to apply a force against the plurality of ribs in response to contact with a corresponding anatomical feature of the user's ear.

21. The headphone apparatus of claim 20, wherein a thickness of the outer wall is greater than a thickness of each of the plurality of ribs.

22. The headphone apparatus of claim 20, wherein a thickness of each of the plurality of ribs is greater than a thickness of the inner wall.

23. The headphone apparatus of claim 20, wherein the outer wall, the inner wall, and the plurality of ribs are integrally formed with one another.

24. The headphone apparatus of claim 20, wherein a first portion of the outer wall, a first portion of the inner wall, and one of the plurality of ribs define a compression opening to enable the outer wall to compress into the compression opening along an axis in response to contact with the anti-helical fold of the user's ear.

25. The headphone apparatus of claim 24, wherein the compression opening forms a first angle that is less than 90 degrees at a first portion thereof.

26. The headphone apparatus of claim 25, wherein the compression opening forms a second angle that is greater than 90 degrees at a second portion thereof, the second portion being positioned opposite to the first portion.

27. The headphone apparatus of claim 20, wherein the flexible tip portion is arcuately shaped to fit within the antihelix of the ear.

28. The headphone apparatus of claim 20, wherein flexible tip moves at least partially along a generally horizontal axis in response to contact with the anti-helical fold.
